(19) United States
(12) Patent Application Publication
(10) Pub. No.: US 2012/0222004 A1
(43) Pub. Date: Aug. 30, 2012

(54) PUBLISHING AND UPDATING OF MULTIDIMENSIONAL MODELS USING ORCHESTRATION TOOLS FOR SOFTWARE OFFERINGS

(75) Inventors: Jerome Labat, San Carlos, CA (US); Ramachandran Varadharajan, Fremont, CA (US); Kalusivalingam Thirugnanam, Bangalore (IN); John Eugene Edward, Fremont, CA (US)

(73) Assignee: INTUIT INC., Mountain View, CA (US)

(21) Appl. No.: 13/034,487

(22) Filed: Feb. 24, 2011

(51) Int. Cl. G06F 9/44

(52) U.S. Cl. 717/120

(57) ABSTRACT

The disclosed embodiments provide a system that facilitates the maintenance and execution of a software offering. During operation, the system obtains model data associated with a multidimensional model of the software offering. Next, the system publishes the model data in a set of orchestration tools for the software offering, wherein the model data enables use of the multidimensional model in managing the execution of the software offering from the orchestration tools.

### RELATED APPLICATION

The subject matter of this application is related to the subject matter in a co-pending non-provisional application by inventors Jerome Labat, Ramachandran Varadharajan, Wilson W. Lau, and Thomas C. Bishop, entitled “Multidimensional Modeling of Software Offerings,” having Ser. No. 13/031,950, and filed on 22 Feb. 2011 (Attorney Docket No. INTU-115591).

The subject matter of this application is also related to the subject matter in a co-pending non-provisional application by inventors Jerome Labat, Ramachandran Varadharajan, Wilson W. Lau, and Thomas C. Bishop, entitled “Automatic Provisioning of Resources to Software Offerings,” having Ser. No. 13/031,968, and filed on 22 Feb. 2011 (Attorney Docket No. INTU-115592).

### BACKGROUND

1 Related Art

The present embodiments relate to techniques for managing software offerings. More specifically, the present embodiments relate to techniques for publishing and updating multidimensional models of the software offerings using orchestration tools for the software offerings.

Recent computing trends have shifted the processing and consumption of data and services to cloud computing systems. Such cloud computing systems allow software providers to deploy, execute, and manage software offerings on shared infrastructure resources such as servers, network equipment, platform-virtualization software, and/or data-center space. Furthermore, such resources may be dynamically provisioned and/or scaled, thus enabling consumption of the resources as services.

For example, a cloud computing provider may provide virtualized storage, network, and/or computing resources to multiple cloud computing customers. The cloud computing customers may deploy software offerings on the virtualized resources and pay the cloud computing provider only for resources consumed by the software offerings. As a result, the cloud computing customers may avoid capital expenditures associated with purchasing, setting up, and/or managing the underlying hardware and software. Furthermore, the centralization and sharing of infrastructure resources may improve the resources' utilization rates and management overhead.

Hence, the deployment, execution, and management of software offerings may be facilitated by mechanisms for dynamically allocating and configuring infrastructure resources used by the software offerings.

### SUMMARY

The disclosed embodiments provide a system that facilitates the maintenance and execution of a software offering. During operation, the system obtains model data associated with a multidimensional model of the software offering. Next, the system publishes the model data in a set of orchestration tools for the software offering, wherein the model data enables use of the multidimensional model in managing the execution of the software offering from the orchestration tools.

In some embodiments, the system also updates the multidimensional model based on execution data for the software offering from one or more of the orchestration tools. The system then modifies the model data in the orchestration tools based on the updated multidimensional model.

In some embodiments, the execution data is associated with at least one of:
(i) a change in a number of service containers allocated to the software offering;
(ii) a resizing of a service container allocated to the software offering; and
(iii) a relocation of the service container.

In some embodiments, publishing the model data in the set of orchestration tools involves sending the model data to the orchestration tools using an interface with each of the orchestration tools. The model data is then published within a hierarchy for the software offering in each of the orchestration tools.

In some embodiments, the hierarchy is at least one of a directory hierarchy and a service hierarchy.

In some embodiments, obtaining the model data involves obtaining a set of elements and a set of mappings from the multidimensional model, and storing the elements and the mappings in a tree structure.

In some embodiments, each of the orchestration tools is used to manage at least one of a computing resource, a network resource, a storage resource, a capacity associated with the software offering, and monitoring of the software offering.

### BRIEF DESCRIPTION OF THE FIGURES

FIG. 1 shows a schematic of a system in accordance with an embodiment.

FIG. 2 shows the publishing and updating of a multidimensional model using a set of orchestration tools in accordance with an embodiment.

FIG. 3 shows a flowchart illustrating the process of facilitating the maintenance and execution of a software offering in accordance with an embodiment.

FIG. 4 shows a computer system in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method and system for facilitating the maintenance and execution of a software offering. The software offering may correspond to an application that is deployed on one or more servers and accessed over a network connection. For example, the software offering may provide a web application, distributed application, and/or web service to users of the software offering.

More specifically, the disclosed embodiments provide a method and system for publishing and updating a multidimensional model of the software offering using a set of orchestration tools for the software offering. The orchestration tools may correspond to tools used to allocate and configure resources for use by the software offering. For example, the orchestration tools may include virtual machine monitors, virtual filers, virtual network systems, virtual load balancers, and/or monitoring systems. The multidimensional model may include a set of service components in the software offering, a set of resources used by the software offering, and a set of dependencies among the service components and/or resources. The multidimensional model may thus facilitate the deployment, execution, and maintenance of the software offering.

To publish the multidimensional model, model data associated with the multidimensional model may be obtained and sent to the orchestration tools using an interface with each of the orchestration tools. The model data may then be published within a hierarchy for the software offering in each of the orchestration tools. Such publishing may enable use of the multidimensional model in managing the execution of the software offering from the orchestration tools without requiring knowledge and/or understanding of the multidimensional model by the orchestration tools.

In addition, changes to the software offering may be tracked by the model and republished within the orchestration tools. In particular, the multidimensional model may be updated based on execution data for the software offering from one or more of the orchestration tools. The model data in the orchestration tools may then be modified based on the updated multidimensional model. Consequently, the disclosed embodiments may increase use of the multidimensional model in managing the software offering across the software development lifecycle of the software offering.

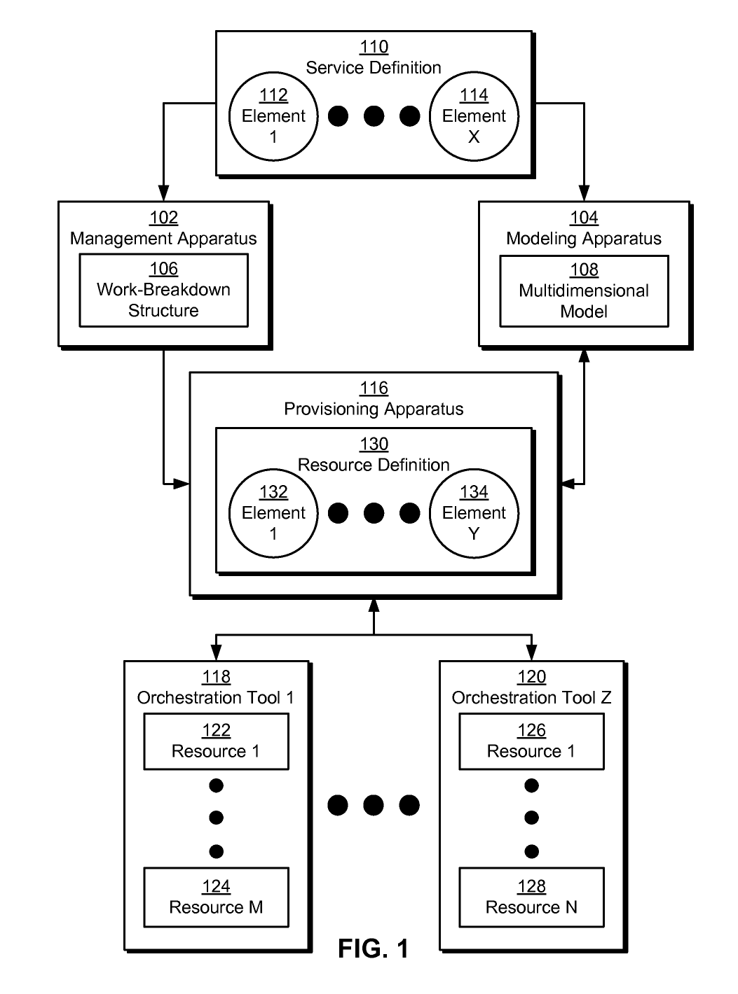

FIG. 1 shows a schematic of a system in accordance with an embodiment. As shown in FIG. 1, the system includes a management apparatus 102, a modeling apparatus 104, and a provisioning apparatus 116. Each of these components is discussed in further detail below.

In one or more embodiments, the system of FIG. 1 is used to manage the deployment and execution of a software offering on a set of resources (e.g., resource 1 122, resource m 124, resource 1 126, resource n 128). The software offering may correspond to a software program that performs tasks for a set of users. For example, the software offering may allow the users to collaborate on projects, file income taxes, manage personal or small business finances, and/or perform data mining on a target data set.

Furthermore, the software offering may be implemented using a client-server architecture. Components of the software offering may be deployed and executed on one or more servers (e.g., in a data center) and accessed from other machines using a locally installed executable, a command-line interface, and/or a web browser and network connection. In other words, the software offering may be implemented using a cloud computing system that is accessed over the Internet.

To enable execution of the software offering, users associated with the creation, deployment, and/or execution of the software offering may determine a set of requirements associated with the software offering. The users may then allocate resources (e.g., resource 1 122, resource m 124, resource 1 126, resource n 128) in the cloud computing system to components in the software offering and configure the allocated resources in a way that allows the executing software offering to meet the requirements. For example, a development team for the software offering may provide a policy specifying a level of availability, reliability, scalability, security, and/or response time in the software offering. Administrators for the cloud computing system may ensure compliance with the policy by allocating sufficient infrastructure resources to the software offering and/or configuring the resources to provide requisite levels of redundancy, security, and/or load balancing in the software offering.

Those skilled in the art will appreciate that the cloud computing system may use virtualization to deploy and execute the software offering on a set of shared resources. In particular, a number of orchestration tools (e.g., orchestration tool 1 118, orchestration tool z 120) may be used to virtualize and/or provision different types of resources in the cloud computing system. For example, a virtual machine monitor may allocate and/or manage computing resources by creating and executing virtual machines as abstractions of physical servers. Similarly, a virtual filer may combine storage resources from a variety of storage devices into a resource pool and allocate logical volumes of storage from the resource pool. Finally, network routers and/or switches may partition network resources into virtual local area networks (VLANs) that connect physical and/or virtual computing and/or storage resources in the cloud computing system.

Moreover, each orchestration tool may include functionality to dynamically re-provision resources in response to changes in the software offering and/or in demand for the resources. For example, a virtual machine monitor may instantiate a new virtual machine to enable the addition of a new web server to the software offering. The virtual machine monitor may also allocate a set of physical computing resources (e.g., processor, memory, etc.) to the virtual machine to enable execution of the web server on the resources. Finally, the virtual machine monitor may move the virtual machine to a different set of physical resources if the web server's resource requirements change and/or the physical resources (e.g., servers) used to execute the web server become overloaded.

In other words, the use of resources by the software offering may be managed by a number of disparate, independently acting orchestration tools. As a result, the cloud computing system may lack a comprehensive view of dependencies between software components in the software offering and the hardware resources used to execute the software components. For example, the cloud computing system may lose track of resources allocated to the software offering once the orchestration tools begin reallocating and/or re-provisioning the resources.

Such lack of dependency information may cause problems with tracking and managing events and/or failures in the cloud computing system. For example, a server outage in the cloud computing system may require manual intervention by administrators to determine the set of hardware and software components affected by the outage and/or perform corrective actions that enable recovery from the server outage.

In one or more embodiments, the system of FIG. 1 reduces complexity associated with managing requirements and dependencies in the software offering by creating a multidimensional model 108 of the software offering and using multidimensional model 108 to manage the deployment and execution of the software offering. As shown in FIG. 1, multidimensional model 108 may be created from a service definition 110 of the software offering and a resource definition 130 of resources available for use by the software offering.

Service definition 110 may be obtained from a user (e.g., developer, architect, etc.) associated with the creation and/or development of the software offering. More specifically, service definition 110 may correspond to a logical representation of the software offering in terms of the software offering's configuration, topology, policies, and/or QoS attributes. As a result, elements (e.g., element 1 112, element x 114) of service definition 110 may include one or more tiers, a set of service components, and/or a set of connections. For example, an architect of the software offering may provide service definition 110 by inputting the number of tiers, level of security, software-development-lifecycle stage, and/or software stack associated with the software offering into a user interface provided by management apparatus 102.

On the other hand, resource definition 130 may be obtained from administrators and/or orchestration tools of the cloud computing system and correspond to a logical representation and/or division of available infrastructure resources in the cloud computing system in terms of the resources' locations, states, and/or utilization. Elements (e.g., element 1 132, element y 134) of resource definition 130 may thus represent physical and/or virtual resources, resource clusters, security zones, hosting segments, and/or locations in the cloud computing system. For example, an administrator may manually populate resource definition 130 with an inventory of physical and/or virtual resources in the cloud computing system, or provisioning apparatus 116 may receive notifications of changes to resources (e.g., addition of new resources, removal of existing resources) in the cloud computing system from the orchestration tools (e.g., virtual machine monitors, virtual filers) and update resource definition 130 accordingly.

To create multidimensional model 108, modeling apparatus 104 may map a first set of elements (e.g., element 1 112, element x 114) from service definition 110 to a second set of elements (e.g., element 1 132, element y 134) from resource definition 130. The mappings may represent dependencies of the first set of elements on the second set of elements. For example, a mapping from a service component in service definition 110 to a resource in resource definition 130 may indicate the allocation of the resource to the service component by an orchestration tool. Creation of multidimensional models for software offerings is discussed in a co-pending non-provisional application by inventors Jerome Labat, Ramachandran Varadharajan, Wilson W. Lau, and Thomas C. Bishop, entitled “Multidimensional Modeling of Software Offerings,” having Ser. No. 13/031,950, and filed on 22 Feb. 2011 (Attorney Docket No. INTU-115591), which is incorporated herein by reference.

In one or more embodiments, the creation of multidimensional model 108 involves the identification of a set of requirements associated with the software offering from service definition 110, as well as the subsequent allocation of a subset of the resources from resource definition 130 to service components in service definition 110 based on the requirements. In particular, management apparatus 102 may determine the software offering's requirements from a set of policies in service definition 110 and store the requirements in a work-breakdown structure 106. The policies may include a software-development-lifecycle policy, a security policy, a software-template policy, a QoS policy, and/or a structural policy. The requirements may thus specify the amount and/or configuration of resources required to satisfy the policies.

Next, provisioning apparatus 116 may use work-breakdown structure 106 to automatically provision a set of resources for use by the software offering without requiring manual configuration of the resources by a user (e.g., administrator). For example, provisioning apparatus 116 may use work-breakdown structure 106 to create a set of service containers for hosting the software offering. Provisioning apparatus 116 may then allocate resources to the service containers by requesting the required amounts and/or configurations of resources from the corresponding orchestration tools. Automatic provisioning of resources to software offerings is discussed in a co-pending non-provisional application by inventors Jerome Labat, Ramachandran Varadharajan, Wilson Lau, and Thomas Bishop, entitled “Automatic Provisioning of Resources to Software Offerings,” having Ser. No. 13/031,968, and filed on 22 Feb. 2011 (Attorney Docket No. INTU-115592), which is incorporated herein by reference.

As mentioned previously, multidimensional model 108 may include dependencies between service components in service definition 110 and resources in resource definition 130. Consequently, modeling apparatus 104 may create multidimensional model 108 by mapping resources allocated by provisioning apparatus 116 to the service components to which the resources were allocated.

Modeling apparatus 104 may also update the mappings based on changes to the provisioned resources. For example, resources provisioned to service components may change as the orchestration tools allocate new resources, deallocate currently allocated resources, and/or use different sets of physical resources to execute virtualized resources (e.g., virtual machines, logical volumes, VLANs, etc.). Such changes may be obtained by provisioning apparatus 116 through querying and/or monitoring of the orchestration tools. The changes may also be used by provisioning apparatus 116 to update resource definition 130. The updates may then be propagated to multidimensional model 108 via modeling apparatus 104.

Because multidimensional model 108 contains an up-to-date representation of service components, resources, and dependencies in the software offering, the system of FIG. 1 may facilitate management of the software offering within the cloud computing system. For example, multidimensional model 108 may facilitate the automatic deployment of the software offering on the allocated resources, identification of resources allocated to the software offering, identification of failures during execution of the software offering, and/or management of changes associated with the software offering or the resources. In other words, the creation and update of multidimensional model 108 may reduce complexity and/or overhead associated with configuration management, fault diagnosis and remediation, deployment, and/or resource provisioning in the software offering.

In one or more embodiments, the system of FIG. 1 further facilitates use of multidimensional model 108 in managing the software offering by using the orchestration tools (e.g., orchestration tool 1 118, orchestration tool z 120) to publish and update multidimensional model 108. First, provisioning apparatus 116 may obtain model data associated with multidimensional model 108 as a set of elements and a set of mappings from multidimensional model 108. Provisioning apparatus 116 may then store the elements and the mappings in a tree structure.

A publishing mechanism provided by provisioning apparatus 116 and/or another component of the system may then publish the model data in the orchestration tools. In particular, the publishing mechanism may send the model data to the orchestration tools using an interface with each of the orchestration tools. The model data may then be published within a hierarchy for the software offering in each of the orchestration tools.

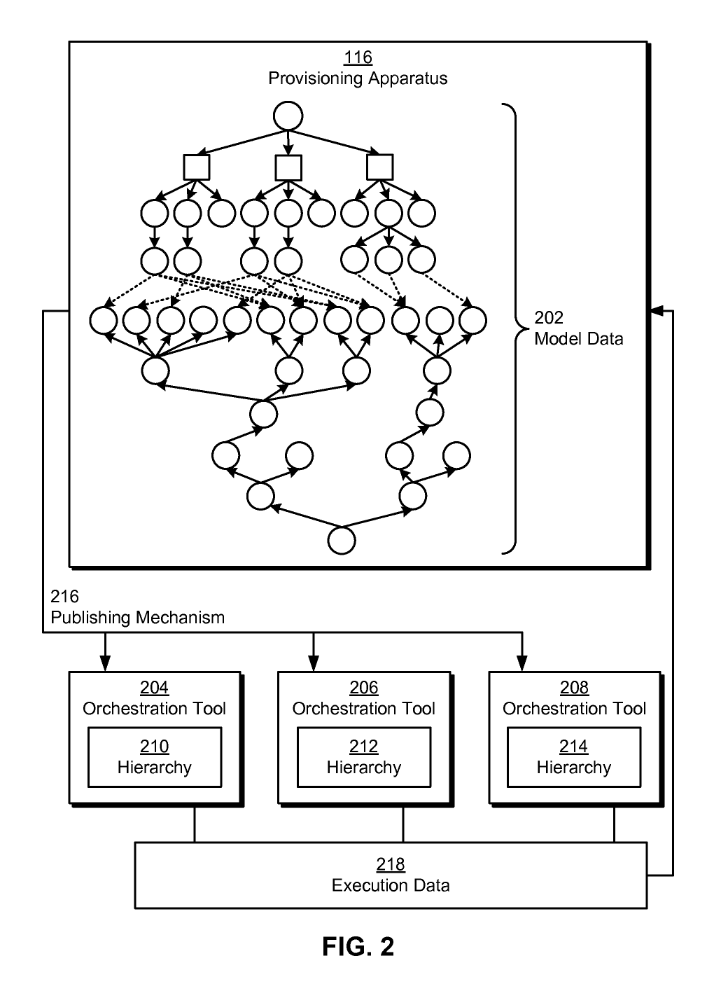

To update multidimensional model 108, provisioning apparatus 116 may obtain execution data for the software offering from one or more of the orchestration tools and update multidimensional model 108 (e.g., using modeling apparatus 104) based on the execution data. For example, provisioning apparatus 116 may use execution data associated with a change in a number of service containers allocated to the software offering, a resizing of a service container allocated to the software offering, and/or a relocation of the service container to update resource definition 130. The updates may then be used by modeling apparatus 104 to change the mappings between elements of multidimensional model 108. After multidimensional model 108 is updated, provisioning apparatus 116 may use the publishing mechanism to modify the model data in the orchestration tools based on the updated multidimensional model 108. Publishing and updating of multidimensional model 108 using orchestration tools for the software offering is discussed in further detail below with respect to FIG. 2.

FIG. 2 shows the publishing and updating of a multidimensional model (e.g., multidimensional model 108 of FIG. 1) using a set of orchestration tools 204-208 in accordance with an embodiment. Orchestration tools 204-208 may be used to manage the provisioning, configuration, and virtualization of various resources used by a software offering. For example, orchestration tools 204-208 may be used to manage computing resources, network resources, storage resources, a capacity associated with the software offering, and/or monitoring of the software offering.

In other words, orchestration tools 204-208 may include virtual machine monitors, virtual filers, virtual network systems (e.g., switches and routers), capacity-management systems (e.g., virtual load balancers), and/or monitoring systems. Moreover, the configuration, virtualization, and/or use of each type of resource (e.g., computing resource, network resource, storage resource, monitoring resource, load-balancing resource) may be managed by a separate orchestration tool. Such distinction and/or separation among orchestration tools 204-208 may result in a lack of access to the multidimensional model by users of orchestration tools 204-208. For example, a conventional virtual machine monitor may not have access to and/or an understanding of the multidimensional model. In turn, an administrator may not be able to view the dependencies associated with virtual machines in the software offering during management of the virtual machines from the virtual machine monitor.

In one or more embodiments, use of the multidimensional model in managing the software offering from orchestration tools 204-208 is enabled by publishing the multidimensional model in orchestration tools 204-208. First, provisioning apparatus 116 may be used to obtain model data 202 associated with the multidimensional model. As discussed in the above-referenced applications, the multidimensional model may map a first set of elements from a service definition of a software offering to a second set of elements representing a set of resources available for use by the software offering. The multidimensional model may thus correspond to a graph structure, with elements in the graph representing service components and/or resources and directed edges in the graph representing dependencies between pairs of elements.

Next, a publishing mechanism 216 may be used to publish model data 202 in orchestration tools 204-208. Publishing mechanism 216 may be provided by provisioning apparatus 116 and/or another component configured to communicate with orchestration tools 204-208. To publish model data 202 in orchestration tools 204-208, publishing mechanism 216 may send model data 202 to orchestration tools 204-208 using an interface with each of the orchestration tools. For example, publishing mechanism 216 may use a set of application programming interfaces (APIs) provided by orchestration tools 204-208 to transmit model data 202 to orchestration tools 204-208.

Each orchestration tool may then publish model data 202 within a pre-existing hierarchy 210-214 used by the orchestration tool to manage use of the resources by the software offering. For example, model data 202 may be published within a directory hierarchy used by a virtual machine monitor to manage and/or organize virtual machines in the software offering. Along the same lines, model data 202 may be published within a virtual filesystem used by a virtual filer to manage and/or organize virtual volumes used by the software offering.

In other words, provisioning apparatus 116 and/or publishing mechanism 216 may convert a graph-based multidimensional model of the software offering into hierarchical model data 202 that is sent to orchestration tools 204-208 and stored within hierarchical structures (e.g., hierarchies 210-214) provided by orchestration tools 204-208. To convert the multidimensional model into model data 202, provisioning apparatus 116 may obtain a set of elements and a set of mappings from the multidimensional model and store the elements and the mappings in a tree structure.

For example, provisioning apparatus 116 may generate a tree structure of model data 202 corresponding to a service hierarchy of elements in the service definition by creating a root node representing the software offering, connecting the root node to a set of tier nodes, connecting each tier node to one or more service nodes, and connecting each service node to one or more other service nodes and/or one or more resource nodes. As a result, model data 202 may contain chains of dependencies from the software offering to architectural components, then service components, and finally, physical and/or virtual resources in the resource definition.

The chains of dependencies in model data 202 may then be published in each orchestration tool by creating a root directory for the software offering within a directory hierarchy provided by the orchestration tool, creating a set of sub-directories representing the tier nodes below the root directory, and creating one or more chains of sub-directories representing the service nodes within each of the sub-directories. Finally, resources managed by each orchestration tool may be placed into the directories corresponding to the service nodes that depend on the resources.

Users of orchestration tools 204-208 may thus use the multidimensional model to manage the execution of the software offering by accessing model data 202 through hierarchies 210-214. For example, an administrator may interact with a virtual machine monitor to manage the use of computing resources (e.g., virtual machines, servers, etc.) by the software offering. To access model data 202 from the virtual machine monitor, the administrator may examine the directory hierarchy associated with the software offering, beginning with the root directory named after the software offering. Next, the administrator may examine a path from the root directory to a computing resource to determine the dependencies of various service components in the software offering on the computing resources. Because directories in the path may be named after the service components, the path may allow the administrator to identify a chain of dependencies from the software offering to the computing resource. In turn, the administrator may use the identified dependencies to modify the allocation, virtualization, use, and/or configuration of computing resources in the software offering.

Furthermore, the use of hierarchies 210-214 provided by orchestration tools 204-208 to publish model data 202 may allow the multidimensional model to be accessed from orchestration tools 204-208 without requiring knowledge and/or understanding of the multidimensional model by orchestration tools 204-208. Instead, users of orchestration tools 204-208 may access the multidimensional model by interpreting the structure and/or names of directories in hierarchies 210-214. Thus, provisioning apparatus 116 and publishing mechanism 216 may allow users of pre-existing orchestration tools 204-208 in a cloud computing system to make informed decisions regarding the use of resources by the software offering without modifying the functionality of orchestration tools 204-208.

Provisioning apparatus 116 may additionally update the multidimensional model based on execution data 218 for the software offering from one or more of the orchestration tools. Execution data 218 may be associated with a change in a number of service containers (e.g., computing service containers, storage service containers, network service containers) allocated to the software offering, a resizing of a service container allocated to the software offering, and/or a relocation of the service container. For example, execution data 218 may be generated whenever an orchestration tool modifies the use of resources by the software offering.

As mentioned above, provisioning apparatus 116 may obtain execution data 218 by continuously querying and/or monitoring orchestration tools 210-214. Provisioning apparatus 116 may then use execution data 218 to update the multidimensional model. For example, provisioning apparatus 116 may update a resource definition (e.g., resource definition 130 of FIG. 1) of resources available for use by the software offering based on execution data 218. The updates may then be propagated to the multidimensional model by a modeling apparatus, such as modeling apparatus 104 of FIG. 1.

In turn, updates to the multidimensional model may be used by provisioning apparatus 116 to modify model data 202 for publishing in orchestration tools 204-208. Consequently, provisioning apparatus 116 and publishing mechanism 216 may maintain an up-to-date representation of dependencies in the software offering in each of the orchestration tools by iteratively updating the multidimensional model based on execution data 218 from orchestration tools 204-208, using the updated multidimensional model to modify model data 202, and publishing model data 202 in orchestration tools 204-208.

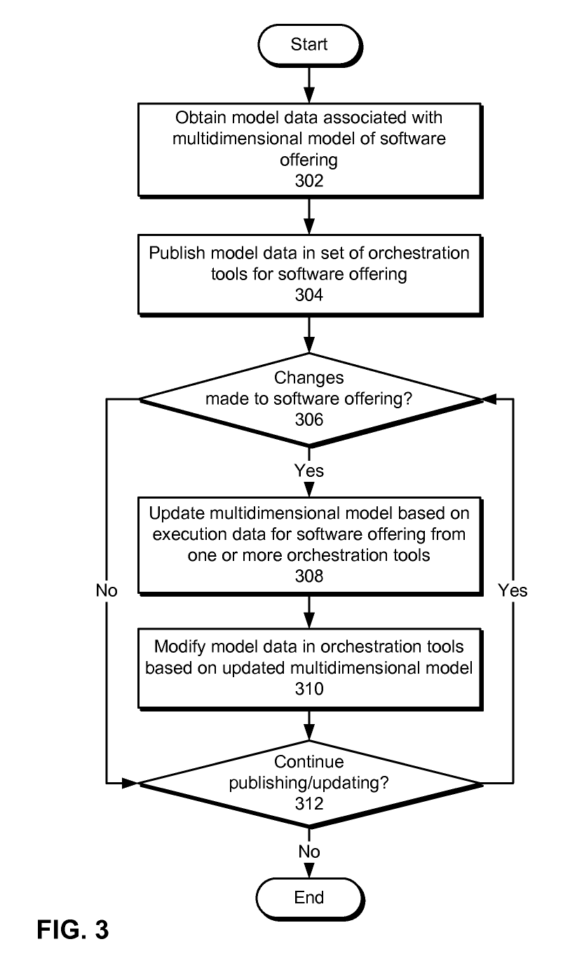

FIG. 3 shows a flowchart illustrating the process of facilitating the maintenance and execution of a software offering in accordance with an embodiment. In one or more embodiments, one or more of the steps may be omitted, repeated, and/or performed in a different order. Accordingly, the specific arrangement of steps shown in FIG. 3 should not be construed as limiting the scope of the technique.

Initially, model data associated with a multidimensional model of the software offering is obtained (operation 302). For example, a set of elements and a set of mappings may be obtained from the multidimensional model and stored in a tree structure to generate the model data. Next, the model data is published in a set of orchestration tools for the software offering (operation 304). For example, the model data may be sent to the orchestration tools using an interface (e.g., API) with each of the orchestration tools. The model data may then be published within a hierarchy for the software offering in each of the orchestration tools.

Changes may also be made to the software offering (operation 306) during execution of the software offering. For example, service containers in the software offering may change in number, size, and/or location in response to changes in the software offering's policies and/or the availability of the resources. If changes have been made to the software offering, the multidimensional model is updated based on execution data for the software offering from one or more of the orchestration tools (operation 308), and the model data in the orchestration tools is modified based on the updated multidimensional model (operation 310). If changes have not been made to the software offering, neither the multidimensional model nor the model data is modified.

The multidimensional model and model data may continue to be published and/or updated (operation 312) during execution of the software offering. For example, the continued publishing and updating of model data in the orchestration tools may facilitate the use of the multidimensional model in managing the execution of the software offering from the orchestration tools throughout the software development lifecycle of the software offering. If publishing and updating is to continue, any changes to the software offering (operation 306) are obtained as execution data from the orchestration tools and used to update the multidimensional model (operation 308). The updated multidimensional model may then be used to modify the model data in the orchestration tools (operation 310). The model data may thus allow users of the orchestration tools to manage the software offering using an up-to-date representation of service components, resources, and dependencies in the software offering.

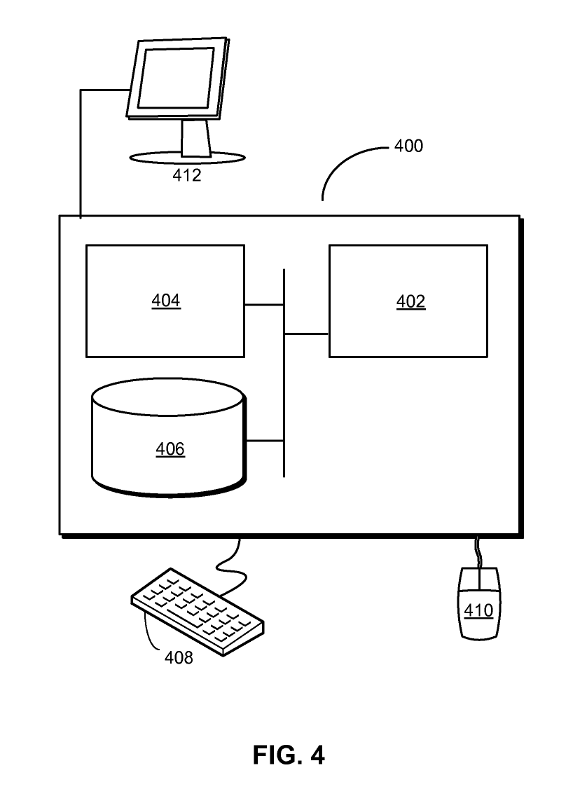

FIG. 4 shows a computer system 400 in accordance with an embodiment. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for facilitating the maintenance and execution of a software offering. The system may include a provisioning apparatus that obtains model data associated with a multidimensional model of the software offering. The system may also include a publishing mechanism that publishes the model data in a set of orchestration tools for the software offering. Furthermore, the provisioning apparatus may update the multidimensional model based on execution data for the software offering from one or more of the orchestration tools, and the publishing mechanism may modify the model data in the orchestration tools based on the updated multidimensional model. As a result, the system may enable use of the multidimensional model in managing the execution of the software offering from the orchestration tools.

In addition, one or more components of computer system 400 may be remotely located and connected to the other components over a network. Portions of the present embodiments (e.g., provisioning apparatus, publishing mechanism, etc.) may also be located on different nodes of a distributed system that implements the embodiments. For example, the present embodiments may be implemented using a cloud computing system that manages the deployment, execution, and maintenance of a software offering.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for facilitating the maintenance and execution of a software offering, comprising:
obtaining model data associated with a multidimensional model of the software offering; and
publishing the model data in a set of orchestration tools for the software offering, wherein the model data enables use of the multidimensional model in managing the execution of the software offering from the orchestration tools.

2. The computer-implemented method of claim 1, further comprising:
updating the multidimensional model based on execution data for the software offering from one or more of the orchestration tools; and
modifying the model data in the orchestration tools based on the updated multidimensional model.

3. The computer-implemented method of claim 2, wherein the execution data is associated with at least one of:
a change in a number of service containers allocated to the software offering;
a resizing of a service container allocated to the software offering; and
a relocation of the service container.

4. The computer-implemented method of claim 1, wherein publishing the model data in the set of orchestration tools involves:
sending the model data to the orchestration tools using an interface with each of the orchestration tools,
wherein the model data is published within a hierarchy for the software offering in each of the orchestration tools.

5. The computer-implemented method of claim 4, wherein the hierarchy is at least one of a directory hierarchy and a service hierarchy.

6. The computer-implemented method of claim 1, wherein obtaining the model data involves:
obtaining a set of elements and a set of mappings from the multidimensional model; and
storing the elements and the mappings in a tree structure.

7. The computer-implemented method of claim 1, wherein each of the orchestration tools is used to manage at least one of a computing resource, a network resource, a storage resource, a capacity associated with the software offering, and monitoring of the software offering.

8. A system for facilitating the maintenance and execution of a software offering, comprising:
a provisioning apparatus configured to obtain model data associated with a multidimensional model of the software offering; and
a publishing mechanism configured to publish the model data in a set of orchestration tools for the software offering, wherein the model data enables use of the multidimensional model in managing the execution of the software offering from the orchestration tools.

9. The system of claim 8,
wherein the provisioning apparatus is further configured to update the multidimensional model based on execution data for the software offering from one or more of the orchestration tools, and
wherein the publishing mechanism is further configured to modify the model data in the orchestration tools based on the updated multidimensional model.

10. The system of claim 9, wherein the execution data is associated with at least one of:
a change in a number of service containers allocated to the software offering;
a resizing of a service container allocated to the software offering; and
a relocation of the service container.

11. The system of claim 8, wherein publishing the model data in the set of orchestration tools involves:
sending the model data to the orchestration tools using an interface with each of the orchestration tools,
wherein the model data is published within a hierarchy for the software offering in each of the orchestration tools.

12. The system of claim 11, wherein the hierarchy is at least one of a directory hierarchy and a service hierarchy.

13. The system of claim 8, wherein obtaining the model data involves:
obtaining a set of elements and a set of mappings from the multidimensional model; and
storing the elements and the mappings in a tree structure.

14. The system of claim 8, wherein each of the orchestration tools is used to manage at least one of a computing resource, a network resource, a storage resource, a capacity associated with the software offering, and monitoring of the software offering.

15. A computer-readable storage medium storing instructions that when executed by a computer cause the computer to perform a method for facilitating the maintenance and execution of a software offering, the method comprising:
obtaining model data associated with a multidimensional model of the software offering; and
publishing the model data in a set of orchestration tools for the software offering, wherein the model data enables use of the multidimensional model in managing the execution of the software offering from the orchestration tools.

16. The computer-readable storage medium of claim 15, the method further comprising:
updating the multidimensional model based on execution data for the software offering from one or more of the orchestration tools; and
modifying the model data in the orchestration tools based on the updated multidimensional model.

17. The computer-readable storage medium of claim 16, wherein the execution data is associated with at least one of:
a change in a number of service containers allocated to the software offering;
a resizing of a service container allocated to the software offering; and
a relocation of the service container.

18. The computer-readable storage medium of claim 15, wherein publishing the model data in the set of orchestration tools involves:
sending the model data to the orchestration tools using an interface with each of the orchestration tools,
wherein the model data is published within a hierarchy for the software offering in each of the orchestration tools.

19. The computer-readable storage medium of claim 18, wherein the hierarchy is at least one of a directory hierarchy and a service hierarchy.

20. The computer-readable storage medium of claim 15, wherein obtaining the model data involves:
obtaining a set of elements and a set of mappings from the multidimensional model; and
storing the elements and the mappings in a tree structure.

21. The computer-readable storage medium of claim 15, wherein each of the orchestration tools is used to manage at least one of a computing resource, a network resource, a storage resource, a capacity associated with the software offering, and monitoring of the software offering.
